(19) United States
(12) Patent Application Publication
(10) Pub. No.: US 2006/0270471 A1
(43) Pub. Date: Nov. 30, 2006

(54) Modular system for electronic assembly units worn close to the body and process for putting same into operation

(75) Inventors: Hans Matthiessen, Bad Schwartau (DE); Henning Gerder, Lubeck (DE); Frank Sattler, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: Drager Safety AG & Co. KGaA, Lubeck (DE)

(21) Appl. No.: 11/372,180

(22) Filed: Mar. 9, 2006

(30) Foreign Application Priority Data
May 24, 2005 (DE) 10 2005 024 450.5

(51) Int. Cl. H04M 1/00

(52) U.S. Cl. 455/575.6

(57) ABSTRACT

A modular system of electronic assembly units worn close to the body has assembly units that can be coupled with a common bus system. The modular system includes at least one control unit, which is designed such that it can assume a master function in respect to additional coupled electronic assembly units. The electronic components coupled with the common bus system are put automatically into operation when a minimum configuration of electronic assembly units is coupled with the common bus system.

### CROSS REFERENCE TO RELATED APPLICATIONS

This application claims the benefit of priority under 35 U.S.C. §119 of German Patent Application DE 10 2005 024 450.5 filed May 24, 2005, the entire contents of which are incorporated herein by reference.

### FIELD OF THE INVENTION

The present invention pertains to a modular system of electronic assembly units worn close to the body, which can be connected via a bus system, and a process for putting same into operation.

### BACKGROUND OF THE INVENTION

It may be necessary or desirable in certain cases to carry various electronic devices or assembly units directly on the body and to operate them simultaneously when needed. Examples can be found in the area of sports and recreational activities as well as professional applications. In particular, mission personnel of technical rescue services such as fire departments, etc., are equipped with numerous electronic devices, whose function is sometimes vitally important, without special attention being able to be paid to their operation in critical situations.

The plurality of electronic devices with which mission personnel is now equipped must all be able to be supplied with power and to communicate with one another electronically.

It is known that electronic components can be integrated in clothing (U.S. Pat. No. 6,729,025 B2), as a result of which the individual components are kept available, in principle, for the wearer of the clothing.

Furthermore, it is known that numerous electronic assembly units worn close to the body can be connected to a central bus system in order to achieve the communication of the individual assembly units (DE 101 20 775 A1).

The attractiveness of such systems is determined essentially by their maximum duration of use, which depends on the capacity and the available power storage means and the power demand of the system.

Numerous moves, which are necessary for the maintenance, configuration or putting into operation of conventional systems, sometimes imply a high risk of error, which may be disadvantageous especially in situations in which little time is available.

### SUMMARY OF THE INVENTION

The object of the present invention is to propose a system that makes it possible with little effort to allow a plurality of electronic components worn close to the body to communicate with one another and to supply them with power, which system can be applied and put into operation with little effort and is characterized by a low power consumption.

Wearing close to the body is defined in the sense of the present invention as at least the carrying along of pieces of equipment, in which there is an unambiguous assignment in space of the pieces of equipment to individual users.

According to the present invention a modular system of assembly units worn close to the body is provided, which assembly units can be coupled with a common bus system. The system comprises at least one control unit, which is designed such that it can assume a master function for additional coupled electronic assembly units. Additional assembly units coupled with the common bus system are put automatically into operation when a minimum configuration of electronic assembly units is coupled with the common bus system. The electronic assembly units are largely switched off outside the operating times. As a result, little battery current is consumed.

The common bus system may be radio-supported and/or contain a line system.

In case of RF (radio frequency) communication of the electronic assembly units with one another, the individual assembly units may be advantageously maintained in a sleep mode outside the operating times and switched briefly to reception at regular time intervals in order to check whether the corresponding master module, i.e., the control unit, is transmitting. If the control unit is not transmitting, the individual assembly units fall back into the sleep mode. When transmission by the control unit can be identified, a response is sent according to a bus protocol and it then waits until the master has checked whether all the assembly units belonging to a fixed minimum configuration are connected to the bus system, i.e., whether, for example, they have reported within a time period specified according to a bus protocol. The electronic assembly units are advantageously provided with an identification, which may be stored, for example, in an ID tag.

When this condition is not met, the entire system falls back into the sleep mode again. The master module will check again after some time which of the modules belonging to the system are present. If all are present, the entire modular system goes into operation.

The triggering of this completeness check may be performed regularly and automatically by the master module. It may be advantageous in certain applications if putting into operation can be forced by pressing a button.

The power consumption of the electronic assembly units is markedly reduced by the sleep mode in the case of non-use, which makes possible, for example, a long-term readiness time of mission personnel.

A component that completes the minimum configuration that is necessary for putting automatically into operation may be a personal RFID tag (transponder) of a user of the equipment in the simplest case. After the mission, removal of an important equipment module, for example, of the personal ID tag, signals to the system by the next completeness check that the operation is to be terminated. All modules will again go over into the sleep mode.

It is advantageous if the belonging of the modules to the particular individual bus system of a user is defined. Such a system configuration can be performed in RF-based systems by a so-called stamping. In an environment in which it is ensured that only the modules belonging to the individual bus system can send or be identified with a signal of sufficient intensity, the control unit detects the identity of all electronic assembly units present during a stamping step for this purpose and stores it in a check file. Then, only modules whose identification is stored in the check file will be addressed via the bus system. Collisions in adjacent radio-supported systems, as they could be expected, for example, in firefighting missions with a plurality of mission personnel, are thus avoided.

In case of person-bound individual equipment, this configuration and stamping may be performed once in the equipment center. The system according to the present invention will then go automatically into operation during a mission in the configured composition only. If the composition of the equipment changes on site, the particular composition selected can be configured on site and thus stamp for one another for the particular mission. This may happen, if necessary, in an at least temporarily screened environment.

If certain pieces of equipment are to be always used, in principle, together, and others shall be optionally added from a pool of equipment on site, the configuration and the stamping may also be carried out in two steps, and it is also possible to make a distinction between pieces of equipment that must be present in the system and those that may be optionally added.

Person-bound modules that are urgently required are provided once with an unchangeable identification, for example, in the mission center. They will then contain an ID code, which shows that the module in question is an obligatory module with connection to a certain bus system.

Obligatory modules without a fixed connection with a single bus system may be provided at first with an unchangeable identification in order to characterize them as an obligatory module.

Optional modules are advantageously provided with a code that regulates the permissibility of participation in the bus communication. These may also include electrically passive pieces of equipment, such as a helmet, masks or pieces of equipment characterized with ID tags.

For use in mission protocols, the configuration information is preferably transmitted to the mission center via a communication device and stored there with the point in time and the duration of the mission.

It may also be advantageous for such a protocolling to equip important non-electric pieces of equipment with RFID tags and to also detect them during a configuration.

It may also be advantageous to use an inductively coupled bus system. In principle, the same procedure can be followed in case of inductively coupled bus systems, and the problem of power supply can be solved, as a rule, in a simpler manner, because the power supply can also be switched on via the bus system from a central power supply unit. In an especially simple embodiment, it is sufficient to embody a sleep mode for the master module only, because the other components can be put automatically into operation by connecting the power supply. In this case, the master module as a control unit is in the sleep mode outside the mission time, from which it wakes up at regular intervals, inductively supplies the connected bus, which may be equipped incompletely, with power, and thus also switches on the connected modules. The master module then performs a check for completeness of the equipment according to the already described rules, and if there is no completeness, the power supply is again switched off immediately and the master module falls back into the sleep mode.

It may again be advantageous if the checking for completeness can be forced immediately by means of an additional button, for example, on the master module. In addition, the degree of completeness of the modular system and the modules still missing may be displayed on a display unit. This display may advantageously also be carried out in the mission center if there is a corresponding communication channel.

In case of an inductively coupled bus system, the stamping of the bus configuration is markedly simpler because of the shorter range. It is only necessary for this procedure for a person to be located somewhat away from other, similarly equipped equipment.

The present invention can be implemented in different ways. One possibility is in a process for putting into operation a modular system of electronic assembly units worn close to the body, in which the control unit, which is designed such that it can assume a master function in respect to other electronic assembly units, is connected to the common bus system and a check is performed to determine whether other electronic assembly units worn close to the body are connected to the common bus system, it detects the coupled electronic assembly units and compares same with a specified minimum configuration, after which the electronic assembly units coupled with the bus system are put into operation when at least the electronic assembly units that belong to the specified minimum configuration are coupled with the common bus system. The addressed detection of the electronic assembly units coupled with the common bus system may be performed cyclically and it may take place additionally or as an alternative when another electronic component is coupled with the common bus system. Depending on the performed detection of the electronic assembly units coupled with the common bus system, these assembly units are put out of operation when the minimum configuration is no longer coupled completely due to the uncoupling of at least one electronic assembly unit.

The present invention can be advantageously implemented when the electronic assembly units worn close to the body can be connected to a central supply system, wherein at least one textile-supported supply line, which leads to inductive interfaces, which can be coupled with the additional supply lines or electronic assembly units, which likewise have at least one inductive interface, is present. Furthermore, the modular system comprises in this advantageous embodiment at least one portable supply module, which has a power supply unit and a control unit, wherein the control unit is in turn designed such that it can assume a master function in respect to other coupled electronic assembly units. The portable supply module likewise has at least one inductive interface and can be coupled with the textile-supported supply line via this inductive interface in such a way that makes possible the power supply of the electronic assembly units by the power supply unit contained in the portable supply module.

Due to power supply via inductive interfaces, plug type contacts are dispensable, as a result of which high safety against sparking is achieved, which is an especially great advantage in case of use in an environment with existing explosion hazard. The use of inexpensive inductive interfaces, if they are suitable, which are available in the form of printed circuits, for example, for checking the tire pressure, is advantageous.

It is especially expedient if the portable supply module is additionally equipped with a radio unit, which is designed for connection to additional mobile or stationary units. Members of mission personnel who are equipped with such a modular system can thus communicate with one another.

Furthermore, assembly units or electronic devices, which are to be carried on the body but whose positioning in a particular area of the body is irrelevant, may also be accommodated in the portable supply module. Thus, it may be advantageous if the portable supply module comprises a telemetry unit, which is designed such that it makes possible the bearing of the user of the modular system according to the present invention in hazardous situations. The assembly units accommodated in the portable supply module are advantageously supplied with power via a direct connection with the power supply unit.

It is especially advantageous if the textile-supported supply line is used not only for the power supply of the individual electronic assembly units, but data can additionally also be transmitted between the electronic assembly units and the central supply module via the textile-supported line. This can be embodied, for example, if the portable supply module and at least one other electronic assembly unit can be coupled with the textile-supported supply line via at least one respective inductive interface in such a way that makes possible, on the one hand, a data transmission between the control unit and the additional electronic assembly unit and, on the other hand, the power supply of the electronic assembly unit by the power supply unit contained in the portable supply module. The textile-supported supply line is now part of the bus system according to the present invention. A ring bus design is advantageous.

The design of the bus will not be described here in detail. The techniques employed are known, in principle. The power transmission is performed, for example, via a 0-1 sequence on the bus, which is sent by the main battery or a bus master. For signal transmission, the signals from the bus participants are modified (attenuated) depending on the bus telegram. Via the inductive interfaces, the bus participants are connected with a respective bus driver, which carries out the modulation of the signal sequence (during transmission) and the reception (with demodulation) of the signals transmitted via the bus.

A plurality of primary coils may be arranged at the bus master in parallel or in series or in a mixed pattern. Series connection of two or more inductive interfaces is also possible.

In addition, electronic assembly units may be contained, which require inductive interfaces and the textile-supported supply line for their power supply only, but, by contrast, they communicate with the control unit and exchange data, for example, via RF interfaces.

If additional interfaces are present, the system according to the present invention can be combined without problems with additional electronic assembly units that have a decentralized power supply unit of their own. These additional interfaces may be designed, for example, as capacitive, conductive or radio-based interfaces. Thus, it is possible to integrate assembly units that do not have an inductive interface but are to be rapidly adapted for certain applications. Flexible systems with high compatibility can thus be assembled.

Hybrid systems with inductive interfaces, which have decentralized power supply units that comprise rechargeable power sources, for example, batteries, are also advantageous. The decentralized power supply units can be charged during phases during which the central supply module and an additional electronic assembly unit with a decentralized power supply unit are coupled with the textile-supported supply line via inductive interfaces. The operation of the electronic assembly units equipped with decentralized power supply units is thus ensured for a certain time even if the central supply module is not available. This may be advantageous, for example, when replacement of the central supply module becomes necessary in critical situations.

The portable supply module may advantageously be part of the equipment parts of a respirator, which are to be carried on the back. The primary coil of the inductive interface on the portable supply module may be advantageously equipped with an open ferrite core in this case.

The textile-supported supply line is advantageously integrated in pieces of clothing, which may be part of the protective clothing of mission personnel.

Any form of flexible electric conductors, which are suitable for the power supply of individual electronic assembly units and/or for data transmission and can be connected with textile structures or comprise textile structures themselves, is defined as a textile-supported supply line in the sense of the present invention.

Especially flat coils for transmitting power and/or signals, which can be integrated in items of clothing, may be considered for use as inductive interfaces. By selecting advantageous positions for the inductive interfaces, it can be achieved that correct placement of the flat coils is automatically achieved simply by putting on or placing on the equipment, which rules out many configuration errors from the very beginning. The inductive interfaces may be integrated, for example, in undershirts, so-called “lifeshirts,” which are equipped with sensors or electrodes, in parts of the outer clothing, in protective suits or respirators. It is frequently ensured already by the shaping of the corresponding pieces of equipment that the transmission coils will always come to lie at the same site and consequently one on top of another. If textile-supported supply lines are integrated in a plurality of components to be worn on the body, it is advantageous if at least one inductive interface is arranged in a location at which at least two of these components to be worn on the body overlap. In the case of protective clothing, this can be achieved, for example, in the area of the collar and the neck apron of a protective helmet, in the overlapping area between pants and the jacket or in the back area. Locations at which a plurality of clothing layers may lie one on top of another without any appreciable shift in position occurring between the clothing layers are suitable for this, in principle.

In case of parts of equipment that are less strictly bound to a particular shape or position, it may be additionally advantageous if means for fixing the position of inductive interfaces are present. These means may comprise, for example, Velcro fasteners or other mechanical fastening means, for example, pockets, pushbuttons, permanent magnets, buttons, etc. Loose electronic parts of equipment may likewise be connected to the system on fastening surfaces prepared for this purpose with coils located under them.

If an inductive interface cannot be embodied in such a way that the pieces of clothing lie fittingly one over the other, it is possible to place a flat coil at the end of a conductor-reinforced, narrow textile web and to place this with a Velcro fastener in a suitable place on an opposite coil. A robust connection is thus established.

Furthermore, it is advantageous if at least one inductive interface is present, which can be reversibly connected to the textile-supported supply line. The modular system according to the present invention can thus be adapted to changing requirements very rapidly, i.e., additional positions can be found for the placement of a plurality of electronic assembly units, which are to communicate with the central control unit or are to be supplied with power from the supply module. The suitable electronic assembly units that must communicate with the central control unit include especially pressure sensors, motion sensors, temperature sensors, means for monitoring vital functions, means for monitoring pieces of equipment, cameras, thermal imaging systems, means for sending data to a base station or various gas sensors, but this list shall not be considered to be exhaustive.

The system according to the present invention may advantageously be used not only for mission personnel, but also for textile bus system solutions in spaceflight, for professional applications, for example, for safety engineers or maintenance technicians, divers, in sports for functional clothing, in the area of the entertainment industry or in medical engineering in the area of home care.

Furthermore, it may be advantageous to arrange the control unit with a radio set in the helmet. Thus, for example, the bus system can be put into operation when the helmet is put on. Only a small battery for the starting operation of the bus master is arranged in the helmet in this case because of the weight. The main power is advantageously obtained from a main battery on the belt or on a backpack.

The present invention will be explained in greater detail on the basis of an exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a minimum configuration according to the present invention with inductively coupled bus system;

FIG. 2 is a schematic view of a system according to the present invention as part of the protective equipment of firefighting mission personnel;

FIG. 3 is a schematic view of a firefighter equipped according to the present invention; and

FIG. 4 is a block diagram of an exemplary system according to the present invention, which operates with RF communication.

### DESCRIPTION OF THE PREFERRED EMBODIMENTS

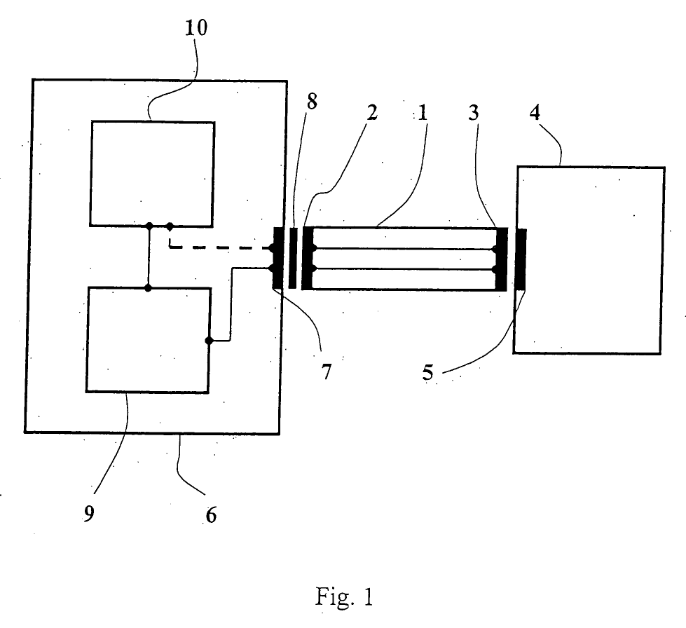

Referring to the drawings in particular, FIG. 1 shows a schematic view of a minimum configuration according to the present invention. A textile-supported supply line 1 ends on both sides at inductive interfaces, which contain flat coils 2, 3. An electronic assembly unit 4 likewise has an inductive interface with a flat coil 5 and can thus be coupled with the textile-supported supply line 1. The other end of the textile-supported supply line 1 leads to a central supply module 6, which is likewise coupled to the textile-supported supply line 1 via an inductive interface with a flat coil 7 and with an open ferrite core 8. The central supply module 6 contains a power supply unit 9 with a battery and a control unit 10.

The electronic assembly unit 4 may contain, for example, sensors for monitoring vital functions. The power necessary for the operation of the sensors is made available by the power supply unit 9 via the textile-supported supply line 1. In addition, a data exchange between the control unit 10 and the electronic assembly unit 4 containing the sensors can take place via the textile-supported supply line 1. The control unit 10 assumes a master function now. It actuates the sensors and coordinates the data polling. The control unit 10 is supplied with power via a direct connection between the control unit 10 and the power supply unit 9. Putting into operation may take place automatically according to the present invention if the central supply module 6 and the electronic assembly unit 4 with its inductive interfaces are connected to the textile supply line 1.

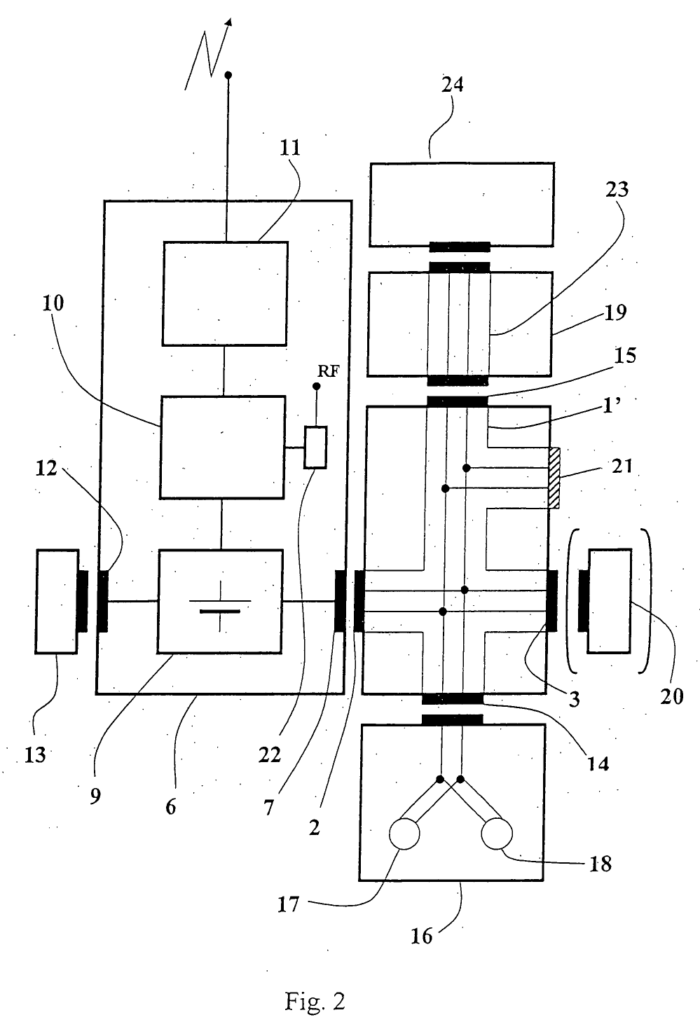

FIG. 2 shows a schematic view of a system according to the present invention as part of the protective equipment of firefighting mission personnel. A central supply module 6 integrated in the backpack of a respirator contains, in turn, a power supply unit 9 with a battery, a control unit 10 and additional a radio unit 11, which is used, for example, for the communication between the user of the protective equipment with other mission personnel. The power supply unit 9, the control unit 10 and the radio unit 11 are connected with one another electrically. The central supply module 6 has inductive interfaces with flat coils 7, 12, which are connected with the power supply unit 9 and with the control unit 10. Additional components, for example, an ID tag 13, can be coupled with these inductive interfaces by means of inductive interfaces. The jacket of a protective suit is equipped in this example with a system of textile-supported supply lines 1′, which likewise end at inductive interfaces with flat coils 2, 3, 14, 15. The jacket is coupled via these interfaces with the central supply module. Additional electronic assembly units worn close to the body can be coupled with the other inductive interfaces on the jacket. In this case, it is a lifeshirt 16 with integrated sensors 17, 18 for measuring the heart rate and the body temperature, a safety mask 19 with integrated display as well as optionally an ID tag 20. The surface of the jacket has an area 21 prepared for receiving another inductive interface. Another flat coil can be connected in this area with the system of textile-supported supply lines 1′ by means of a Velcro system. It would thus be possible to supply another electronic assembly unit having an inductive interface with power via the system of textile-supported supply lines 1′. Due to the fact that exchange of data between the control unit 10 and the other electronic assembly units also takes place via the inductive interfaces, besides the power supply, the system according to the present invention also represents at the same time a bus system that can be expanded in a versatile manner, via which the communication of the individual electronic assembly units with the control unit 10 can take place, the control unit 10 having the function of a master. The control unit 10 additionally has a radio interface 22. Communication with electronic components that cannot participate in the data exchange with the control unit 10 via inductive interfaces is possible via this radio interface 22. The connected safety mask has a line 23, which is suitable for extending the bus system and leads to inductive interfaces. It is thus possible to couple additional electronic assembly units, for example, sensors or antennas integrated in a helmet 24, with the safety mask 19 and to include them in the power supply and communication concept.

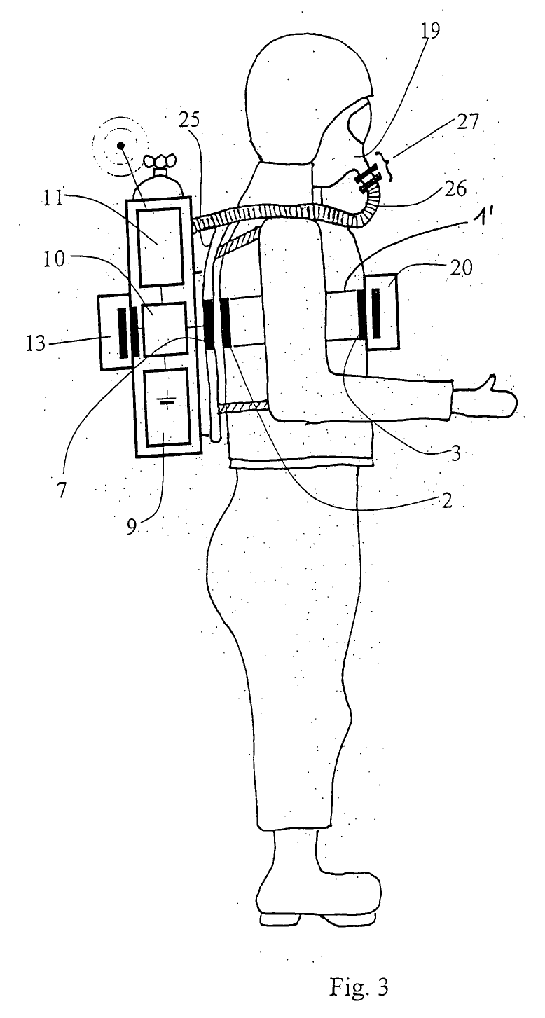

FIG. 3 shows a view of a firefighter equipped according to the present invention. The central supply module with the power supply unit 9, the control unit 10 and the radio unit 1 1 is permanently connected with the support shell 25 of a respirator. A system of textile-supported supply lines 1′, which leads to inductive interfaces with flat coils 2, 3, is integrated in the jacket of the protective suit. The central supply module is connected with the textile-supported supply line via an inductive interface 7 in the back area. A lifeshirt is likewise coupled with the inductive interface 7 in the back area via a flat coil (not visible). The connection of the individual components via inductive interfaces is used for the power supply by the power supply unit 9 and the data exchange with the control unit 10. ID tags 13, 20 may be integrated with the protective clothing or directly with the central supply module, for example, via inductive interfaces in the breast area. Capacitive interfaces may also be used for connecting ID tags. A breathing tube 26 leads to the breathing mask 19. The breathing tube 26 is likewise used as a supply line in this example and it likewise has at its mask-side end an inductive interface 27 for the connection of electronic components in the breathing mask 19.

Other possibilities for connecting electronic components in the breathing mask 19 are according to the present invention the use of inductive interfaces in the overlapping area of the protective clothing and the breathing mask or the use of large induction coils, for example, in the shoulder or helmet area, which make possible coupling over a greater distance.

The entire system is configured in this exemplary embodiment such that the individual electronic assembly units can be supplied with power and switched on and participate in the communication simply by putting on the equipment. The system of textile-supported supply lines is thus also part of the bus system at the same time.

An advantage of such a bus system is that the electronic components can be optionally placed in different locations, depending on where the component causes less disturbance. For example, a gas-measuring device can thus be better arranged on the back than on the chest in case of crawling.

Due to the design as a single or double ring bus in case of especially demanding applications, higher reliability of operation can be achieved if there is a risk of wire break.

The power consumption of the central power supply unit is markedly reduced by the sleep mode in case of non-use. It is sufficient if short-term checking operating cycles are switched to the bus at longer intervals of time in order to check whether all the modules important for the mission are put on. If the important participants of the bus are present completely, the power supply goes into continuous operation. It may likewise be advantageous to specify the presence of a single important component as the criterion of switching on for the continuous operation. Such an important component may be an ID tag of the user of the equipment in the simplest case. This personal ID tag of a person participating in the mission is provided with an inductive interface and can be either coupled on any desired surface or on a surface provided for that purpose, or it is already built somewhere into the clothing or the helmet if these objects are personally assigned to the person participating in the mission. The identification of the user of the system according to the present invention can be brought about automatically with the establishment of the bus communication.

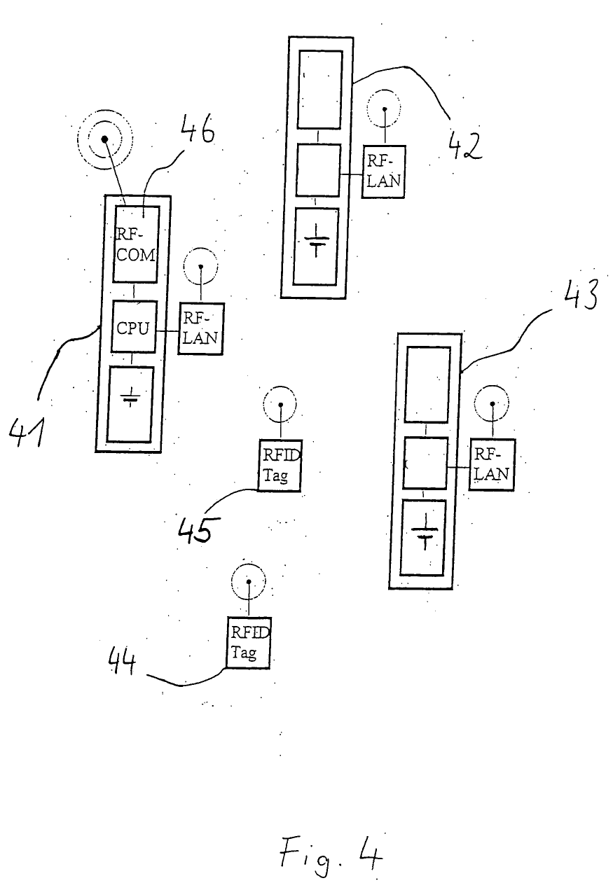

FIG. 4 shows the block diagram of an exemplary system according to the present invention, which operates with RF communication. It comprises a master module 41 as a control unit, a display module 42 and a sensor module 43. The three modules have a battery each of their own. Furthermore, passive RFID tags 44, 45 may be integrated in a minimum configuration necessary for the automatic putting into operation. The master module 41 has a radio unit 46 for external communication. An advantage of the RF-based bus system is likewise that the electronic components can be optionally placed in different locations, depending on where the component is less disturbing. The automatic putting into operation of the system simply by putting on the equipment is also possible in such a system.

While specific embodiments of the invention have been shown and described in detail to illustrate the application of the principles of the invention, it will be understood that the invention may be embodied otherwise without departing from such principles.

What is claimed is:

1. A modular system of units worn close to the body, the system comprising:
a common bus system;
electronic assembly units worn close to the body that may be coupled and uncoupled to the common bus system; and
a control unit for assuming a master function in respect to coupled said electronic assembly units and for automatically putting into operation said electronic assembly units coupled with the common bus system when a minimum configuration of electronic assembly units is coupled with the common bus system.

2. A modular system in accordance with claim 1, wherein said common bus system is supported by a radio frequency (RF) transmission.

3. A modular system in accordance with claim 1, wherein the common bus system comprises a line system.

4. A modular system in accordance with claim 1, further comprising:
a portable supply module having a power supply unit and said control unit, wherein said common bus system comprises a textile-supported supply line having inductive interfaces, said electronic assembly units worn close to the body each having an inductive interface and being connectable and disconnectable to said central supply module via respective said textile-supported supply line inductive interfaces, said portable supply module being coupled to said textile-supported supply line via at least one of said inductive interfaces in such a way that makes possible the power supply of said electronic assembly units by said power supply unit contained in said portable supply module.

5. A modular system in accordance with claim 4, wherein said portable supply module has a radio unit for connection with additional mobile or stationary units.

6. A modular system in accordance with claim 4, wherein said portable supply module comprises a telemetry unit.

7. A modular system in accordance with claim 4, wherein said portable supply module and at least one additional electronic assembly unit can be coupled with said textile-supported supply line via at least one inductive interface each in such a way that data transmission between said control unit and said additional electronic assembly unit is made possible.

8. A modular system in accordance with claim 4, wherein said portable supply module and at least one of said electronic assembly units have an RF interface for data transmission between said control unit and at least one of said electronic assembly units.

9. A modular system in accordance with claim 4, wherein at least one of said additional electronic assembly units has a decentralized power supply unit.

10. A modular system in accordance with claim 9, wherein said decentralized power supply unit comprises a battery, which can be charged during phases during which said portable supply module and said additional electronic assembly unit are coupled with said textile-supported supply line via inductive interfaces.

11. A modular system in accordance with claim 4, wherein said portable supply module is part of a respirator equipment arrangement with means to be carried on the back of a user.

12. A modular system in accordance with claim 1, further comprising a helmet wherein said control unit is accommodated in said helmet.

13. A modular system in accordance with claim 1, further comprising protective clothing wherein said common bus system is integrated in said protective clothing.

14. A modular system in accordance with claim 4, wherein said textile-supported supply line comprises a ring bus.

15. A modular system in accordance with claim 4, wherein said inductive interfaces comprise flat coils.

16. A modular system in accordance with claim 4, wherein at least one said inductive interface can be reversibly connected with said supply line.

17. A modular system in accordance with claim 4, wherein said supply line includes plural line portions each integrated in one of a plurality of components to be worn on the body and at least one said inductive interface is arranged at a location at which there is an overlap between at least two of these components to be worn on the body.

18. A modular system in accordance with claim 1, further comprising fixing means for fixing the position of said inductive interfaces.

19. A modular system in accordance with claim 4, wherein said electronic assembly units, each with a inductive interface, each comprise one or more of a pressure sensor, a motion sensor, a temperature sensor, means for monitoring vital functions, means for monitoring pieces of equipment, a camera, a thermal imaging system, means for sending data to a base station and a gas sensor.

20. A modular system in accordance with claim 1, wherein at least one of said inductive interfaces is equipped with an open ferrite core.

21. A process for putting into operation a modular system of electronic assembly units worn close to the body, the process comprising:
providing a common bus system;
providing electronic assembly units worn close to the body that may be coupled and uncoupled to the common bus system;
coupling one or more of the electronic assembly units worn close to the body to the common bus system;
providing a control unit for assuming a master function in respect to coupled electronic assembly units;
connecting the control unit with the common bus system and checking with the control unit whether electronic assembly units worn close to the body are coupled with said common bus system and detecting coupled electronic assembly units and comparing detected coupled electronic assembly units with a preset specified minimum configuration; and
putting electronic assembly units coupled with said common bus system into operation when at least said electronic assembly units that belong to the specified minimum configuration are coupled with said common bus system.

22. A process in accordance with claim 21, wherein a detection of said electronic assembly units coupled with said common bus system is performed cyclically.

23. A process in accordance with claim 21, wherein a detection of said electronic assembly units coupled with said common bus system is performed automatically when an additional electronic assembly unit is coupled with said common bus system.

24. A process in accordance with claim 21, wherein said electronic assembly units coupled with said common bus system are stopped, put out of operation or powered down when the minimum configuration is no longer coupled completely due to the uncoupling of at least one said electronic assembly unit.

25. A process in accordance with claim 21, wherein said electronic assembly units coupled with said common bus system are maintained in a power-saving sleep mode when they are not put into operation.

26. A process in accordance with claim 21, further comprising:
ensuring that only modules belonging to the individual bus system can send or be identified with a signal of sufficient intensity by using the control unit to detect the identity of all electronic assembly units present during a stamping step for this purpose; and
storing the results of said stamping step in a check file corresponding to a configured composition;
during subsequent operation using the bus system to address only modules whose identification is stored in the check file.

27. A process in accordance with claim 26, wherein upon the composition of the equipment changing during use, the particular composition selected ban be configured by adding the identity of additional assembly units and storing the results in the check file corresponding to a new configured composition.

28. A process in accordance with claim 21, further comprising:
providing optional modules with a code that regulates the permissibility of participation in the bus communication.

29. A process in accordance with claim 26, further comprising:
providing an additional equipment article with an ID tag and detecting the additional equipment article during a configuration.

30. A process in accordance with claim 21, further comprising:
transmitting configuration information to a mission center via a communication device and storing the configuration information with a point in time and a duration of the mission at the mission center.

31. A process in accordance with claim 21, wherein the common bus system is an inductively coupled bus system and a power supply is switched on via the bus system from a central power supply unit.
